(19) United States
(12) Patent Application Publication
(10) Pub. No.: US 2014/0002498 A1
(43) Pub. Date: Jan. 2, 2014

(54) APPARATUS AND METHOD FOR CREATING SPATIAL AUGMENTED REALITY CONTENT

(71) Applicant: Electronics and Telecommunications Research Institute, Daejeon (KR)

(72) Inventors: Jun-Sup LEE, Daejeon (KR); Su-Woong LEE, Daejeon (KR); Jin-Young YOUN, Seoul (KR); Suk-Hyun LIM, Seoul (KR); Gil-Haeng LEE, Seoul (KR)

(21) Appl. No.: 13/925,735

(22) Filed: Jun. 24, 2013

(30) Foreign Application Priority Data
Jun. 27, 2012 (KR) 10-2012-0069363

(51) Int. Cl. G06T 19/00

(52) U.S. Cl. CPC G06T 19/006
USPC 345/633

(57) ABSTRACT

Disclosed herein is an apparatus and method for creating spatial augmented reality content, which enable interaction with a user. In the method, a stationary object in a real space in which a user is located is defined, and then a virtual space is generated. A dynamic object in the real space is defined, and the dynamic object is converted into a primitive object. The primitive object is arranged in the virtual space and then spatial augmented content is created. A multimedia object is paired with the primitive object, and then a virtual space object is generated. Interaction between the virtual space object and a gesture of the user is defined in a format of event script. The virtual space object and the interaction are packaged in the spatial augmented content and packaged results are provided to the user.

### CROSS REFERENCE TO RELATED APPLICATION

This application claims the benefit of Korean Patent Application No. 10-2012-0069363, filed on Jun. 27, 2012, which is hereby incorporated by reference in its entirety into this application.

### BACKGROUND OF THE INVENTION

1. Technical Field

The present invention relates generally to an apparatus and method for creating spatial augmented reality content and, more particularly, to an apparatus and method for creating spatial augmented reality content, which enable interaction with a user.

2. Description of the Related Art

A spatial augmented display enables matching content to be directly projected on a dynamic object present in the real space of a user and to be mapped to the dynamic object. Further, a spatial augmented display is a system for providing a spatial interaction-centered content service, which deforms corresponding content depending on interaction with the user, displays a user space reflecting the deformed content, and supports direct three-dimensional (3D) touch interaction with the user.

In such a spatial augmented display, an apparatus for creating spatial augmented content is essentially required so as to create general-purpose spatial augmented content corresponding to various user spaces. Such a spatial augmented content creation apparatus abstracts dynamic spaces of various users and dynamic objects within the spaces, arranges various objects, such as 3D content, in the abstracted dynamic spaces and dynamic objects, and enables an interactive operation corresponding to the user's behavior to be implemented.

A conventional creation method for augmented spaces, Media Facade, or projection mapping is the method of fully scanning a real space in advance to normalize the real space, creating 3D content matching the results of normalization, and then projecting the 3D content into the real space via post-processing. Such a conventional creation method is applied only to a fully-scanned single stationary space, and is then problematic in that the corresponding content cannot be utilized in other spaces.

### SUMMARY OF THE INVENTION

Accordingly, the present invention has been made keeping in mind the above problems occurring in the prior art, and an object of the present invention is to provide an apparatus and method for creating spatial augmented content, which enable interaction with a user.

Another object of the present invention is to provide an apparatus and method for creating spatial augmented content, which can create general-purpose content corresponding to various dynamic real spaces that are unspecific and denormalized.

In accordance with an aspect of the present invention to accomplish the above objects, there is provided a method of creating spatial augmented content including defining a stationary object in a real space in which a user is located, and then generating a virtual space; defining a dynamic object in the real space, and converting the dynamic object into a primitive object; arranging the primitive object in the virtual space and then creating spatial augmented content; pairing a multimedia object with the primitive object, and then generating a virtual 3D object; defining interaction between the virtual 3D object and a gesture of the user in a format of event script; and packaging the virtual 3D object and the interaction in the spatial augmented content and providing packaged results to the user.

Preferably, the stationary object may correspond to at least one of a wall, a floor, a pillar, and a ceiling present in the real space.

Preferably, the dynamic object may correspond to a dynamically movable object, such as a desk, a chair, a bed, a wardrobe, a table, or a box that is present in the real space of the user, or an environmental object, such as a tree that is not included in the stationary object.

Preferably, the converting the dynamic object into the primitive object may be configured to convert the dynamic object into a primitive object corresponding to a shape of at least one of a rectangular parallelepiped, a regular hexahedron, a cone, a cylinder, a regular tetrahedron, and a sphere.

Preferably, the multimedia object may correspond to an object including at least one of a three-dimensional (3D) model, a two-dimensional (2D) image, video, sound, and text that are externally created, and correspond to an article that may be present in the real space.

Preferably, the creating the spatial augmented content may be configured to emulate the virtual space object so that when the primitive object is moved in the virtual space, the virtual space object is also moved in conjunction with the primitive object.

Preferably, the providing the packed results may be configured to provide the packaged results in a single form into which an eXtensible Markup Language (XML), content script, and multimedia source files are integrated.

In accordance with another aspect of the present invention to accomplish the above objects, there is provided an apparatus for creating spatial augmented content, including a real space emulation unit for abstracting an object in a real space in which a user is located into a stationary object and a primitive object and generating a virtual space including the stationary object primitive object; a multi-augmented space emulator unit for pairing a multimedia object with the stationary object and the primitive object in the virtual space and then generating a virtual space object; an event-based creation supporting unit for defining interaction between the virtual space object and a gesture of the user in a format of event script; and an augmented space reproduction display unit for packaging the virtual space object and the interaction in the spatial augmented content, and providing packaged results to the user.

Preferably, the real space emulation unit may generate a virtual space by defining a stationary object among objects in the real space in which the user is located, convert a dynamic object among the objects into a primitive object, and arrange the primitive object in the virtual space, thus creating the spatial augmented content.

Preferably, the stationary object may correspond to at least one of a wall, a floor, a pillar, and a ceiling present in the real space.

Preferably, the dynamic object may correspond to a dynamically movable object, such as a desk, a chair, a bed, a wardrobe, a table, or a box that is present in the real space of the user, or an environmental object, such as a tree that is not included in the stationary object.

Preferably, the real space emulation unit may convert the stationary/dynamic object into a primitive object corresponding to a shape of at least one of a rectangular parallelepiped, a regular hexahedron, a cone, a cylinder, a regular tetrahedron, a sphere, and a plane.

Preferably, the multi-augmented space emulator unit may emulate the virtual space object so that when the primitive object is moved in the virtual space, the virtual space object is also moved.

Preferably, the augmented space reproduction display unit may provide the packaged results in a single form into which an eXtensible Markup Language (XML), content script, and multimedia source files are integrated.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a configuration diagram schematically showing an apparatus for creating spatial augmented content according to an embodiment of the present invention;

FIG. 2 is a flowchart showing a method of creating spatial augmented content according to an embodiment of the present invention;

FIGS. 3 to 7 are reference diagrams showing the method of creating spatial augmented content according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those who have ordinary knowledge of the art to which the present invention pertains. Accordingly, in the drawings, the shapes and sizes of elements may be exaggerated for the sake of clearer description.

Hereinafter, an apparatus and method for creating spatial augmented content according to embodiments of the present invention will be described in detail with reference to the attached drawings.

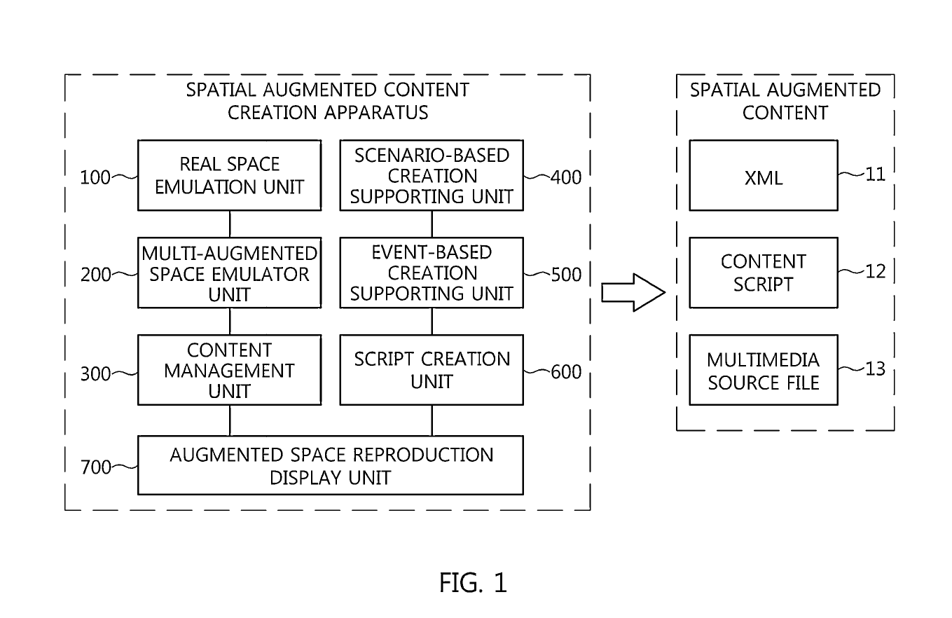

FIG. 1 is a configuration diagram schematically showing an apparatus for creating spatial augmented content according to an embodiment of the present invention.

Referring to FIG. 1, the apparatus for creating spatial augmented content includes a real space emulator unit 100, a multi-augmented space emulator unit 200, a content management unit 300, a scenario-based creation supporting unit 400, an event-based creation supporting unit 500, a script creation unit 600, and an augmented space reproduction display unit 700.

The real space emulator unit 100 constructs a virtual space by abstracting an object corresponding to at least one of a table, a wall, a floor, a pillar, a ceiling, a desk, a chair, and a box disposed in a real space in which a user is located, into a primitive object. In this case, the primitive object may correspond to a rectangular parallelepiped, a regular hexahedron, a cone, a cylinder, a regular tetrahedron, a sphere, a plane, or the like.

The multi-augmented space emulator unit 200 receives a multimedia object, such as an externally created 3D object, in the virtual space constructed by the real space emulator unit 100, and then generates a virtual space object by pairing (-binding) the multimedia object with the primitive object in the virtual space.

The content management unit 300 may include, but is not limited to, a script debugger, a 3D configuration generation and management module, a projector management unit, etc.

The scenario-based creation supporting unit 400 can configure all functions using simple script upon creating content based on a specific scenario.

The event-based creation supporting unit 500 defines interaction between the virtual space object generated by the multi-augmented space emulator unit 200 and the gesture of the user based on the interaction points of the user (for example, hands, feet, and head) in the format of event script.

The script creation unit 600 creates content based on the script format defined by the event-based creation supporting unit 500.

The augmented space reproduction display unit 700 packages the created content, together with eXtensible Markup Language (XML), content script, and multimedia source files, in a single form, and provides the packaged form to the user.

The XML includes information about the primitive object, the virtual space object corresponding to the primitive object, and the SRT (Scale+Rotation+Translation) of the virtual space object relative to the primitive object. Here, the SRT includes scale, rotation, and translation.

The content script includes not only information about the primitive object and deformation information about the virtual space object, but also events related to the progress of content scenarios, such as multimedia events composed of sound, video, etc., in the format of script. Here, the deformation information about the virtual space object denotes the results of deformation of the virtual space object occurring due to the gesture events of the user based on the interaction points of the user and lighting and sound events in the real space.

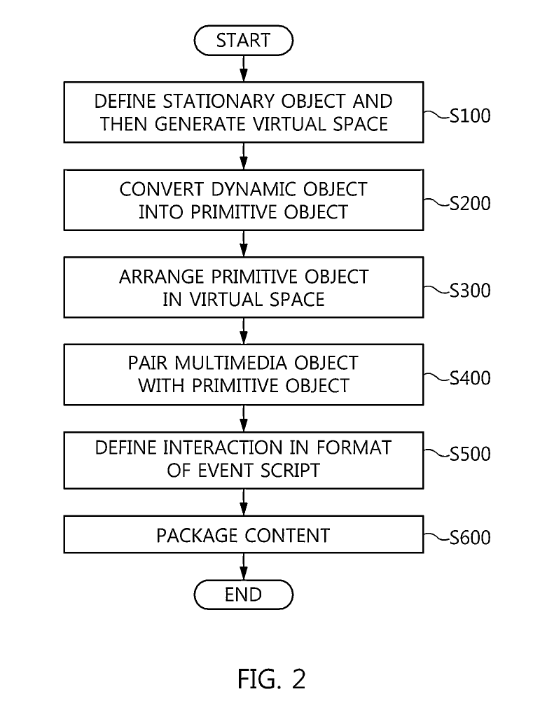

Next, a method of creating spatial augmented content will be described in detail with reference to FIG. 2.

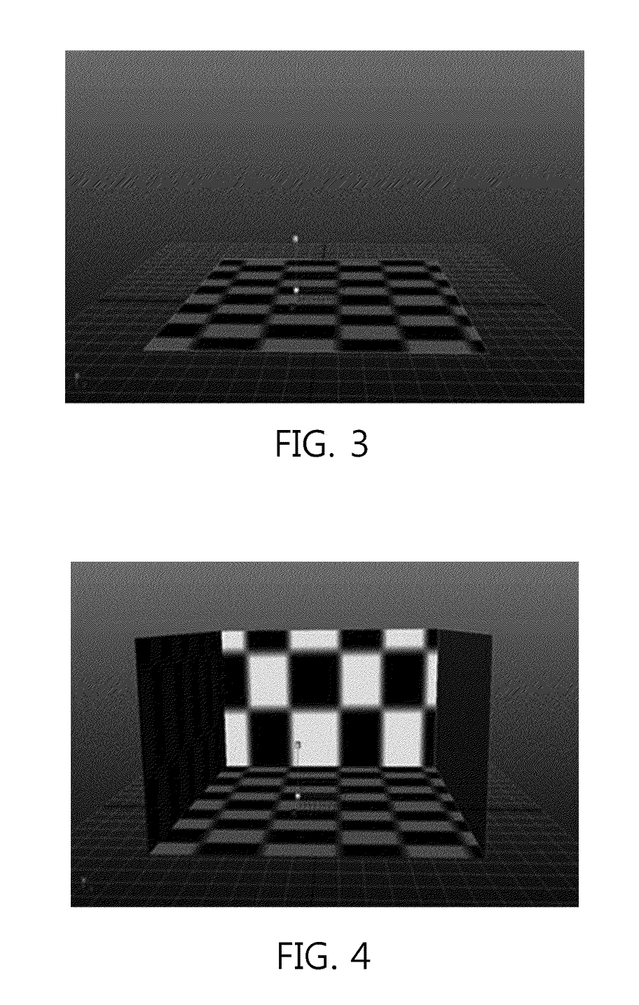

FIG. 2 is a flowchart showing a method of creating spatial augmented content according to an embodiment of the present invention. FIGS. 3 to 8 are reference diagrams showing the method of creating spatial augmented content according to an embodiment of the present invention.

Referring to FIG. 2, the spatial augmented content creation apparatus generates a virtual space by defining a stationary object in a real space in which a user is located at step S100. Here, the stationary object can include a wall, a floor, a pillar, a ceiling, etc.

In detail, the spatial augmented content creation apparatus constructs a virtual space by abstracting an object in the real space in which the user is located into a stationary object among primitive objects. For example, the spatial augmented content creation apparatus defines a “wall” corresponding to the object in the real space, in the form of a stationary object, and then generates a virtual space as shown in FIG. 4 in a basic space as shown in FIG. 3.

Referring to FIG. 4, the spatial augmented content creation apparatus defines a stationary object, such as a wall, a floor, a pillar, or a ceiling which is present in the unspecified real space of the user, in the virtual space, and randomly arranges the stationary object, thus mapping the spatial augmented content to regions corresponding to the floor, wall, pillar, and ceiling in an arbitrary real space, even if the spatial augmented content is applied to the arbitrary real space.

The spatial augmented content creation apparatus defines a dynamic object in the real space in which the user is located, and converts the dynamic object into a primitive object at step S200. Here, the dynamic object corresponds to an object dynamically movable in the real space of the user, such as a desk, a chair, a bed, a wardrobe, a table, or a box, or an environmental object, such as a tree that is not included in the stationary object.

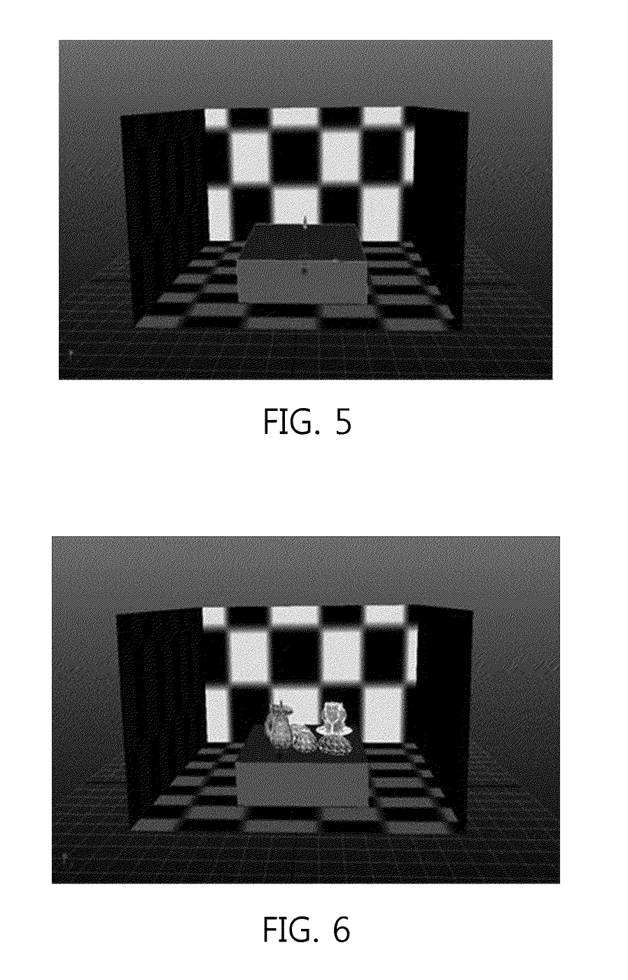

The spatial augmented content creation apparatus arranges the primitive object in the virtual space, generated at step S100, at step S300. For example, as shown in FIG. 5, the spatial augmented content creation apparatus arranges a primitive object having the shape of a rectangular parallelepiped in the virtual space (see FIG. 4) generated at step S100. Here, the primitive object is the result of abstracting a dynamic object that is always movable, or an environmental object that is not included in the stationary object. The spatial augmented content creation apparatus arranges the primitive object in the virtual space, thus creating the virtual space including the primitive object, that is, spatial augmented content.

The spatial augmented content creation apparatus receives a multimedia object, such as an externally created 3D object, in the virtual space, pairs (binds) the multimedia object with the primitive object in the virtual space, and then generates a virtual space object at step S400. For example, as shown in FIG. 6, the spatial augmented content creation apparatus pairs multimedia objects corresponding to articles (for example, a water bottle, a wineglass, a dish, etc.), with the primitive object having the shape of the rectangular parallelepiped in the virtual space.

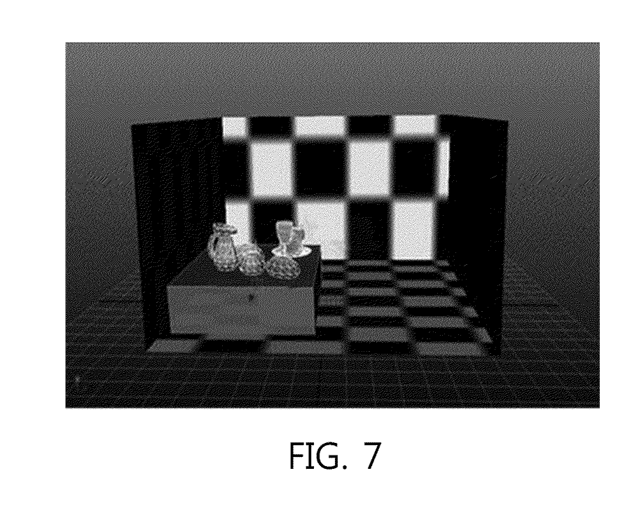

The spatial augmented content creation apparatus emulates the virtual space (3D) object generated via the above procedure so that when the primitive object is moved in the virtual space, the virtual 3D object is also moved. For example, when a primitive object that has the shape of a rectangular parallelepiped in the virtual space corresponds to a table in the real space, the virtual 3D object paired with the primitive object is projected as long as the corresponding table is abstracted into a primitive object having the shape of a rectangular parallelepiped, regardless of the location at which the table is disposed, as shown in FIG. 7.

The spatial augmented content creation apparatus defines interaction between the virtual 3D object and the gesture of the user based on the interaction points of the user (for example, hands, feet, and head) in the format of event script at step S500. In this case, the gesture of the user may include touching or dragging the multimedia object, raising hands, or walking. For example, the spatial augmented content creation apparatus enables the corresponding multimedia object that is paired with the primitive object to be deformed (for example, a change in color or the like) when the user makes a gesture, such as touching the multimedia object.

The spatial augmented content creation apparatus packages the virtual 3D object and the event script-format interaction in the spatial augmented content, and provides the packaged results to the user at step S500. In this case, the spatial augmented content creation apparatus provides the packaged results, that is, the final content to be provided to the user, in a single form into which of XML, content script, and multimedia source files are integrated.

In this way, the present invention abstracts various denormalized objects in the real space of the unspecified user into primitive objects when creating spatial augmented content, and defines virtual 3D objects to be projected into the real space of the user via a projector by pairing the 3D objects with the primitive objects, thus enabling general-purpose spatial augmented content or projection mapping content that is applied to various user spaces to be created.

In accordance with the embodiments of the present invention, the apparatus and method for creating spatial augmented content enable user spaces to be displayed, so that spatial interaction-centered content that supports direct 3D touch interaction with the user can be created.

Further, in accordance with the embodiment of the present invention, the apparatus and method for creating spatial augmented content are configured to abstract various denormalized stationary or dynamic objects in the real space of an unspecified user into primitive objects when creating spatial augmented content, and define virtual 3D objects to be projected into the real space of the user via a projector by pairing the virtual 3D objects with the corresponding primitive objects, thus enabling general-purpose spatial augmented content or projection mapping content that is applied to various user spaces to be created.

Furthermore, the present invention can create content capable of improving immersion and experience in various application services, education, edutainment, performance, etc., by projecting interactive 3D content into an existing space. Such content can be provided to the user in various forms, such as for interactive space role-play learning content, 3D space multi-room content, and interactive 3D virtual stage performance content.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method of creating spatial augmented content, comprising:
defining a stationary object in a real space in which a user is located, and then generating a virtual space;
defining a dynamic object in the real space, and converting the dynamic object into a primitive object;
arranging the primitive object in the virtual space and then creating spatial augmented content;
pairing a multimedia object with the primitive object, and then generating a virtual space object;
defining interaction between the virtual space object and a gesture of the user in a format of event script; and
packaging the virtual space object and the interaction in the spatial augmented content and providing packaged results to the user.

2. The method of claim 1, wherein the stationary object corresponds to at least one of a wall, a floor, a pillar, and a ceiling present in the real space.

3. The method of claim 1, wherein the dynamic object includes at least one of movable objects including at least one of a desk, a chair, a bed, a wardrobe, a table, a box, and unspecified objects arranged depending on an environment, the unspecified objects including at least one of a tree and a signboard, the movable objects and the unspecified objects present in the real space.

4. The method of claim 1, wherein the converting the dynamic object into the primitive object is configured to convert the dynamic object into a primitive object corresponding to a shape of at least one of a rectangular parallelepiped, a regular hexahedron, a cone, a cylinder, a regular tetrahedron, and a sphere.

5. The method of claim 1, wherein the multimedia object corresponds to an object including at least one of a three-dimensional (3D) model, a two-dimensional (2D) image, video, sound, and text that are externally created, and corresponds to an article that may be present in the real space.

6. The method of claim 1, wherein the creating the spatial augmented content is configured to emulate the virtual space object so that when the primitive object is moved in the virtual space, the virtual space object is also moved.

7. The method of claim 1, wherein the providing the packed results is configured to provide the packaged results in a single form into which an eXtensible Markup Language (XML), content script, and multimedia source files are integrated.

8. An apparatus for creating spatial augmented content, comprising:
a real space emulation unit for abstracting an object in a real space in which a user is located into a primitive object and generating a virtual space including the primitive object;
a multi-augmented space emulator unit for pairing a multimedia object with the primitive object in the virtual space and then generating a virtual space object;
an event-based creation supporting unit for defining interaction between the virtual space object and a gesture of the user in a format of event script; and
an augmented space reproduction display unit for packaging the virtual space object and the interaction in the spatial augmented content, and providing packaged results to the user.

9. The apparatus of claim 8, wherein the real space emulation unit generates a virtual space by defining a stationary object among objects in the real space in which the user is located, converts a dynamic object among the objects into a primitive object, and arranges the primitive object in the virtual space, thus creating the spatial augmented content.

10. The apparatus of claim 9, wherein the stationary object corresponds to at least one of a wall, a floor, a pillar, and a ceiling present in the real space.

11. The apparatus of claim 9, wherein the dynamic object includes at least one of movable objects including at least one of a desk, a chair, a bed, a wardrobe, a table, a box, and unspecified objects arranged depending on an environment, the unspecified objects including at least one of a tree and a signboard, the movable objects and the unspecified objects present in the real space.

12. The apparatus of claim 8, wherein the real space emulation unit converts the dynamic object into a primitive object corresponding to a shape of at least one of a rectangular parallelepiped, a regular hexahedron, a cone, a cylinder, a regular tetrahedron, and a sphere.

13. The apparatus of claim 8, wherein the multi-augmented space emulator unit emulates the virtual space object so that when the primitive object is moved in the virtual space, the virtual space object is also moved.

14. The apparatus of claim 8, wherein the augmented space reproduction display unit provides the packaged results in a single form into which an eXtensible Markup Language (XML), content script, and multimedia source files are integrated.
